(19) United States
(12) Patent Application Publication
(10) Pub. No.: US 2012/0073037 A1
(43) Pub. Date: Mar. 29, 2012

(54) TEMPERATURE-CONTROLLABLE HEATED SEAT AND HEATED BIDET

(75) Inventors: Jeong Yeon KIM, Seoul (KR); Young Hyuck LEE, Seoul (KR)

(73) Assignee: WOONGJIN COWAY CO., LTD., Choongcheongnam-do (KR)

(21) Appl. No.: 13/245,166

(22) Filed: Sep. 26, 2011

(30) Foreign Application Priority Data
Sep. 27, 2010 (KR) 10-2010-0093438
Sep. 30, 2010 (KR) 10-2010-0095507
Sep. 21, 2011 (KR) 10-2011-0095220

(51) Int. Cl. E03D 9/08; H05B 1/00

(52) U.S. Cl. 4/420.2; 219/217

(57) ABSTRACT

A temperature-controllable heated seat includes: a housing providing a certain amount of internal space; heating wires disposed within the housing, having bent portions repeated from one end portion to the other end portion of the housing, and heating the housing upon receiving power; and a thermostat unit disposed at a periphery of the heating wires and controlling power supply to the heating wires such that the temperature of the housing does not exceed a pre-set temperature value.

### CROSS-REFERENCE TO RELATED APPLICATIONS

This application claims the priority of Korean Patent Application No. 10-2010-0093438 filed on Sep. 27, 2010, No. 10-2010-0095507 filed on Sep. 30, 2010 and No. 10-2011-0095220 filed on Sep. 21, 2011, in the Korean Intellectual Property Office, the disclosure of which is incorporated herein by reference.

### BACKGROUND OF THE INVENTION

1. Field of the Invention

The present invention relates to a heated seat and a heated bidet, whose surface is heated by using heating wires, is controlled so as not to exceed an allowable temperature value.

2. Description of the Related Art

A related art bidet employs a polyvinyl chloride (PVC) nichrome wire heating type heater to heat a toilet seat. The PVC nichrome wire heating type heater has good heating characteristics, incurs low manufacturing costs, and has a relatively simple manufacturing process, so it is therefore commonly used as a bidet toilet seat heater.

However, in the case of the PVC nichrome wire heating type heater, in terms of operational characteristics, a possibility exists in which overvoltage may be applied, while in terms of structural characteristics, a surface temperature of a toilet seat may have variations of up to 7 degrees Celsius.

Also, the related art bidet includes a temperature sensor and an electronic control device for controlling the temperature of the toilet seat. The temperature sensor measures the temperature of the toilet seat and the electronic control device changes a voltage or current supplied to the toilet seat to adjust the temperature thereof. However, in terms of the structural characteristics thereof, the related art PVC nichrome wire heating type heater has wide variations in surface temperature, so a portion of the heater not available for measurement by a temperature sensor may have temperature exceeding an allowable temperature value.

Also, in general, a bidet is installed in a bathroom (or lavatory), a space having high humidity and a great deal of splashed water, so water may be introduced into the bidet. The introduction of water into the bidet may cause the temperature sensor and the electronic control device disposed within the bidet to malfunction and consequently, to potentially excessively increase the temperature of the toilet seat.

### SUMMARY OF THE INVENTION

An aspect of the present invention provides a temperature-controllable heated toilet seat and a heated bidet having a structure for controlling a surface temperature of a heated seat or a bidet so as not to exceed an allowable value.

According to an aspect of the present invention, there is provided a temperature-controllable heated toilet seat including: a housing providing a certain amount of internal space; heating wires disposed within the housing, having bent portions repeated from one end portion to the other end portion of the housing, and heating the housing upon receiving power; and a thermostat unit disposed at a periphery of the heating wires and controlling a power supply thereto, such that the temperature of the housing does not exceed a pre-set temperature value.

The thermostat unit may be separated from the heating wires by a predetermined distance, the predetermined distance may range from 1 mm to 5 mm, and the pre-set temperature value may range from 43 degrees Celsius to 47 degrees Celsius.

The thermostat unit may be disposed above the heating wires, and the pre-set temperature value may range from 40 degrees Celsius to 44 degrees Celsius.

The degree of precision of the thermostat unit may range from 0.5 degrees Celsius to 2.5 degrees Celsius.

The thermostat unit may include a thermostat and wire connection terminals, and the wire connection terminals and wires connected thereto may be integrally molded.

According to another aspect of the present invention, there is provided a temperature-controllable heated bidet including: a toilet seat providing a certain amount of internal space; heating wires disposed within the toilet seat, having bent portions repeated from one end portion to the other end portion of the toilet seat, and heating the toilet seat upon receiving power; and a thermostat unit disposed at a periphery of the heating wires and controlling power supply thereto, such that the temperature of the toilet seat does not exceed a pre-set temperature value.

According to another aspect of the present invention, there is provided a method for controlling a temperature of a heated bidet, including: a toilet seat heating operation of heating a toilet seat by supplying power to heating wires; a power cutoff operation of cutting a power supply by disconnecting the heating wires and a power source by a thermostat when the temperature of the toilet seat reaches a pre-set temperature value; and a power re-supply operation of resuming power supply by connecting the heating wires and the power source by the thermostat when the temperature of the toilet seat is dropped to be lower than the pre-set temperature value.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating a currently implemented toilet seat heater including the related art PVC nichrome wires, a surface temperature of the toilet seat when a heater is actuated, and an increase in the surface temperature;

FIG. 2 is a schematic view showing the configuration of a heating seat according to an embodiment of the present invention;

FIG. 3 is a schematic view showing the configuration of a heated toilet seat according to another embodiment of the present invention;

FIG. 4 is a layout view showing a layout relationship between a temperature sensor and heating wires (or hot wires) according to an embodiment of the present invention; and

FIG. 5 is a view showing a connection relationship between a thermostat and wires according to an embodiment of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In describing the present invention, if a detailed explanation of a related known function or construction is considered to unnecessarily divert the gist of the present invention, such explanation will be omitted but would be understood by those skilled in the art.

In the drawings, the shapes and dimensions may be exaggerated for clarity, and the same reference numerals will be used throughout to designate the same or like components.

Unless explicitly described to the contrary, the word “comprise” and variations such as “comprises” or “comprising,” will be understood to imply the inclusion of stated elements but not the exclusion of any other elements.

Prior to an explanation of a temperature-controllable heated toilet seat and heated bidet according to an embodiment of the present invention, the structure and characteristics of the related art PVC nichrome wire heating type heater will be briefly described.

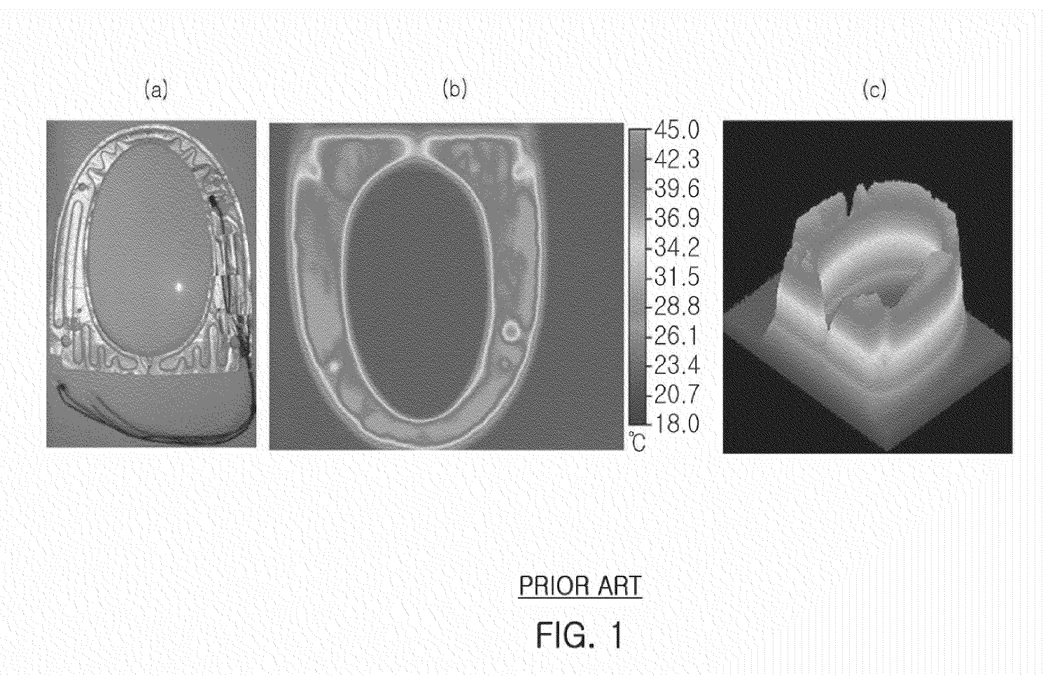

FIG. 1 is a view illustrating a currently implemented toilet seat heater including the related art PVC nichrome wires, a surface temperature of the toilet seat when a heater is actuated, and an increase in the surface temperature of the toilet seat.

FIG. 1(a) shows a currently implemented toilet seat heater including the related art PVC nichrome wires.

With reference to FIG. 1(a), in a toilet seat heater including the related art PVC nichrome wires, nichrome wires are disposed in a lower portion of an upper case of the toilet seat and a power device is connected to the nichrome wires.

A resistance value of the nichrome wires is not greatly changed over a temperature within a usage temperature range of a general toilet seat heater. Thus, when an applied voltage is uniform, current flowing in the nichrome wires is almost constant and there is little change in power consumed in the nichrome wires over temperature. Therefore, without a device for controlling power supply, the temperature of the heater will continue to be increased until a thermal equilibrium condition, in which quantity of heat lost due to heating of the heater is equal to consumed power, is reached.

Namely, the toilet seat heater including the related art PVC nichrome wires requires a device for controlling a temperature of the heater by regulating the magnitude of the voltage applied to the nichrome wires and time in order to attain stability in use and efficiency in power consumption.

Also, many countries are preparing a safety guidelines limiting maximum allowable temperatures, and the like, or limiting a maximum allowable current, or the like, in heaters directly used by individuals. Thus, preferably, a cutoff device for cutting a power supply when a maximum allowable temperature is reached is required to ensure the stability of the heater. Here, a generally used cutoff device may be a device using a heat sensor (temperature sensor) or an electronic control device.

In detail, the cutoff device may measure a temperature value of the toilet sheet by using the heat sensor and transmit the measured temperature value to a control device such as a microcomputer, or the like. The microcomputer may compare the temperature value of the toilet sheet with a pre-set temperature value. When the temperature value of the toilet sheet is lower than the pre-set temperature value, the microcomputer may supply power to the nichrome wires, and when the temperature value of the toilet sheet is higher than the pre-set temperature value, the microcomputer may cut power supply to the nichrome wires.

Namely, the related art cutoff device using the heat sensor and the electronic control device utilizes a method of feeding back temperature of a housing and electrically controlling it.

FIGS. 1(b) and 1(c) illustrate a surface temperature of the toilet seat and an increase in the surface temperature when the toilet sheet heater including the related art PVC type nichrome wires is actuated, respectively.

With reference to FIGS. 1(b) and 1(c), it is noted that, in the toilet seat heater including the related art PVC type nichrome wires, temperature are quickly increased in upper portions of nichrome wires, so surface portions above the nichrome wires have a high surface temperature, while temperatures are slowly increased in portions where nichrome wires are not disposed, so that the portions without the nichrome wire disposed therebelow have lower surface temperatures. In particular, with reference to FIG. 1(b), the toilet seat has surface temperature variations of a maximum 7 degrees Celsius.

Thus, when the cutoff device using the related art heat sensor and the electronic control device is used, since there is a significant difference between the measured surface temperatures according to a position of the heat sensor, power of the heater may be cut off at a position exceeding a maximum allowable temperature or the heater may be cut off at a position in which the temperature of the heater has not been properly increased.

In particular, the recent US UL1431 standard stipulates that the surface temperature of the toilet seat in contact with a human body for nearly one hour should not exceed 41 degrees Celsius based on ambient temperature of 25 degrees Celsius in order to prevent damage to the human body by the heater.

Also, in the case of a cutoff device using the heat sensor and the electronic control device, primary control is made by software installed in the electronic control device, and such an electronic control device is stipulated to be subjected to software evaluation (or examination) by an NRTL laboratory designated by UL and US OSHA. Thus, the use of the electronic control device makes it difficult to manufacture a product and comply with the standard.

Thus, the present invention proposes a temperature-controllable heated toilet seat and heated bidet whose temperature can be controlled to be below a maximum allowable temperature without using a cutoff device using a heat sensor and an electronic control device in consideration of surface temperature variations.

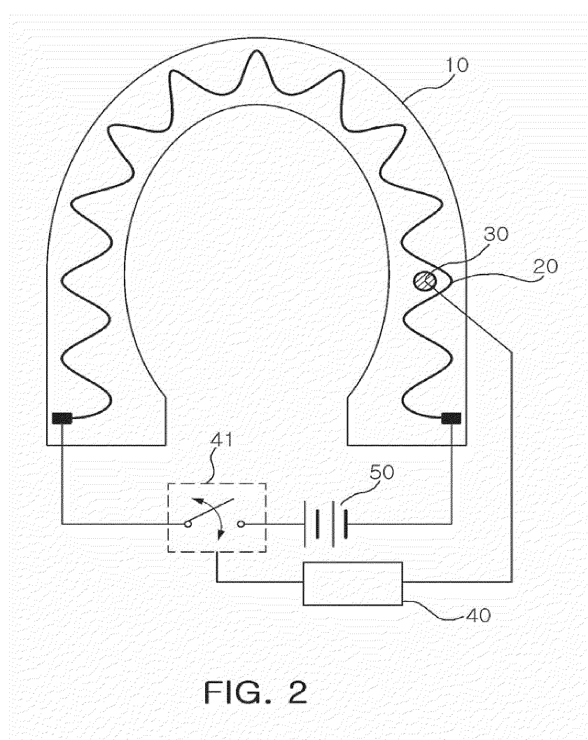

FIG. 2 is a schematic view showing the configuration of a heated toilet seat according to an embodiment of the present invention.

With reference to FIG. 2, the heated toilet seat according to an embodiment of the present invention may include a housing 10, heating wires 20, a temperature sensor 30, and a cutoff unit 40.

The housing 10 provides a certain internal space, forming a seat. The housing 10 for a toilet seat may have a shape such as that shown in FIG. 2, but the housing 10 may be manufactured to have various other shapes, such as a circular shape, an oval shape, a quadrangular shape, or the like.

The heating wires 20 are disposed within the housing 10, including winding portions repeatedly continued from one end portion to the other end portion of the housing 10. The heating wires 20 may be provided with power to heat the housing 10. The heating wires 20 may be formed of PVC type nichrome wires, or the like. The heating wires 20 may be arranged to have a repeated shape at regular intervals in order to evenly heat the overall housing.

The temperature sensor 30 is disposed near the heating wires 20 to measure a surface temperature of the housing 10. The temperature sensor 20 may be disposed in the vicinity of the heating wires 20 to measure the amount of thermal energy generated from the heating wires 20, as temperature.

However, the temperature sensor 30 employed in the related art toilet seat, or the like, has a large temperature measurement interval. However, in order to precisely control temperature to comply with the altered standard, temperature is required to be minutely or finely controlled, so the temperature sensor 30 having a small temperature measurement interval is required.

Besides, when the housing 10 is heated by the heating wires 20, the degree of heating is different in different positions of the surface of the housing 10. Namely, the surface temperature of the housing 10 has variations. Here, since a maximum allowable temperature must be satisfied in spite of the variations of the surface temperature, it is required to estimate a maximum value of the surface temperature of the housing 10 by accurately adjusting the disposition of the temperature 30 and analyzing a measured temperature.

Preferably, the temperature sensor 30 may be disposed at a periphery of the heating wires in the vicinity of one end or the other end of the housing 10. Here, since the intervals of the heating wires 20 are easily obtained, the temperature sensor 30 can be easily disposed.

Also, since the temperature sensor 30 is an electric device, it may be vulnerable to moisture, and the presence of the heating wires 20 at the periphery is highly likely to cause a short circuit to result in a breakdown. Thus, preferably, the temperature sensor 30 and the heating wires 20 at the periphery are waterproofed and may be integrally manufactured as necessary.

The temperature sensor 30 may be positioned at a periphery of the heating wires 20, and the difference between a temperature measured at the corresponding position and a maximum surface temperature can be experimentally extracted. The difference may be affected by the structure of the housing 10, the disposition of the heating wires 20, the distance between the heating wires 20 and the temperature sensor 30, and the like.

When a measured value of the temperature sensor 30 is higher than a pre-set temperature value, the cutoff unit may cut off power supply to the heating wires 20 to prevent the surface temperature of the housing 10 from exceeding the maximum allowable value.

Namely, the cutoff unit 40 receives information regarding the amount of thermal energy emitted by the heating wires 20 from the temperature sensor 30 and estimates a maximum value of the surface temperature of the housing 10. When the maximum value exceeds the maximum allowable value, the cutoff unit 40 cuts off power supply to the heating wires 20. Also, when the maximum value of the surface temperature of the housing 10 is lower than the allowable value, the cutoff unit 40 may resume power supply to the heating wires 20.

The pre-set temperature value may be set in consideration of the difference between the measurement temperature of the temperature sensor 30 and the maximum surface temperature.

A switch 41 may be provided at a portion of a path along which power is supplied to the heating wires 20, and power supply may be cut off by switching the switch 41 according to a control signal from the cutoff unit 40.

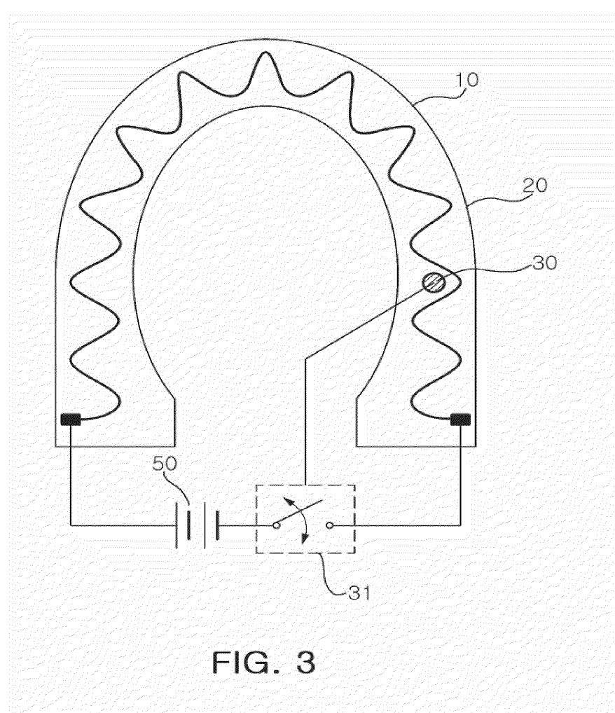

FIG. 3 is a schematic view showing the configuration of a heated toilet seat according to another embodiment of the present invention.

With reference to FIG. 3, the heated toilet seat according to an embodiment of the present invention may include the housing 10, the heating wires 20, and the temperature sensor 30.

The housing 10 and the heating wires 20 have been described above, so a repeated description thereof will be omitted.

The temperature sensor 30 may be disposed at a periphery of the heating wires 20 and control power supply to the heating wires 20 such that temperature of the housing 10 cannot exceed a pre-set temperature value. The temperature sensor 30 may determine only whether or not a measurement temperature has reached the pre-set temperature value in order to prevent a maximum surface temperature of the housing 10 from exceeding the allowable value. When a measurement temperature reaches the pre-set temperature value, power supply to the heating wires 20 from a power source 50 may be cut off by opening the switch 31. Also, when a measurement temperature is dropped to be lower than the pre-set temperature value, the switch 31 may be closed to again supply power to the heating wires 20.

An element having the foregoing characteristics may be a thermostat or a bi-metal.

In detail, a case in which the heated toilet seat according to an embodiment of the present invention uses a thermostat will hereinafter be described.

The thermostat is an element including both the temperature sensor 30 and the switch 31. Namely, the thermostat may be configured as a bi-metal formed by attaching two alloys each having a different expansion coefficient with respect to heat. The thermostat may perform both functions of the temperature sensor 30 and the switch 31 by using the qualities of the bi-metal which is bent in a different degree according to temperature.

The thermostat may connect the heating wires 10 and the power source 50 by using the bi-metal, and when the temperature of the housing 10 reaches a pre-set temperature value, the bi-metal is bent to disconnect the heating wires 20 and the power source 50.

Conversely, when the temperature of the housing 10 is decreased to be lower than the pre-set temperature value, the bi-metal is returned to its original state, connecting the heating wires 20 and the power source 50.

Here, the thermostat may use a bi-metal whose bending degree, according to temperature, is minute and accurate. Preferably, the thermostat may have the degree of precision ranging from 0.5 degrees Celsius to 2.5 degrees Celsius. Namely, when a measured temperature is different by about 0.5 degrees Celsius to 2.5 degrees Celsius from the pre-set temperature value, the thermostat may open or connect the power source 50 and the heating wires 20. Here, the thermostat may include both characteristics of the temperature sensor 30 and the cutoff unit 40. In detail, like the temperature sensor 30, the thermostat may be positioned at a periphery of the heating wires 20, and a maximum value of the surface temperature of the housing 10 may be estimated and when the maximum value exceeds the maximum allowable value, the thermostat may cut off power supply to the heating wires 20. Thereafter, when the maximum value of the surface temperature of the housing decreases to be lower than the allowable value, the thermostat may supply power again to the heating wires 20.

When the thermostat is utilized in this manner, whether or not to supply power to the heating wires 20 can be mechanically determined according to the temperature of the housing 10. Thus, the same controlling operation can be simply implemented compared with the related art method of using the temperature sensor and the electronic control device to control power supply to the heating wires 20 by using a separate program, or the like.

Also, the utilization of the thermostat is advantageous in that the thermostat itself serves as a temperature sensor, eliminating the necessity of a temperature sensor, and since the thermostat may serve as a fuse, the necessity of an element such as a temperature fuse, or the like is eliminated.

As described above, the utilization of the thermostat simplifies the configuration, reducing a cause of a breakdown, and in the event of a breakdown, the cause of the breakdown can be clearly recognized.

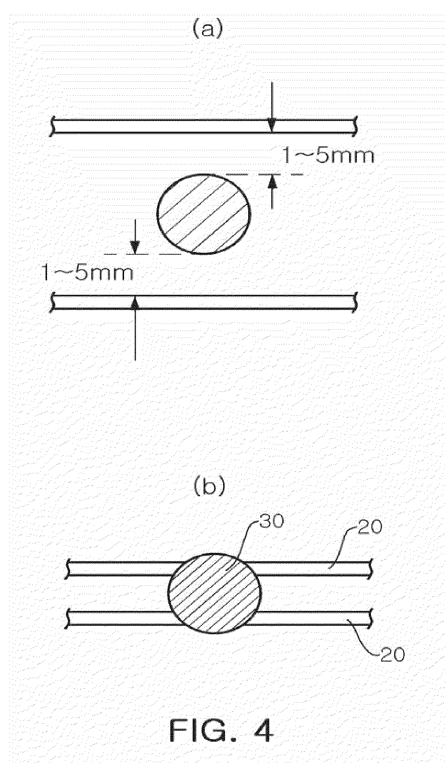

FIG. 4 is a layout view showing a layout relationship between the temperature sensor and the heating wires according to an embodiment of the present invention.

With reference to FIG. 4, the temperature sensor 30 may be disposed between the heating wires 20 or at an upper portion of the heating wires 20.

As shown in FIG. 4(a), when the temperature sensor 30 is disposed between the heating wires 20, the difference between a measured temperature and the maximum surface temperature of the housing 10 varies according to the distance between the temperature sensor 30 and the heating wires 20.

As shown in FIG. 4(b), when the temperature sensor 30 is disposed above the heating wires 20, since a large quantity of heat is received from the heating wires 20, a measured temperature may become higher than the maximum surface temperature of the housing 10.

A method for controlling power supply in the heated bidet or the heated toilet seat in order to satisfy the UL1431 standard when the dispositions of the temperature sensor 30 illustrated in FIG. 4 are applied to the configurations of the FIGS. 2 and 3 will be described.

As shown in FIG. 4(a), when the temperature sensor 30 is disposed between the heating wires 20, when temperature ranging from 40 degrees Celsius to 44 degrees of Celsius is sensed by the temperature sensor 30, a maximum surface temperature of the housing 10 may be lower than 41 degrees Celsius. In this case, the temperature sensor 30 is separated from the heating wires 20 by 1 mm to 5 mm.

As shown in FIG. 4(b), when the temperature sensor 30 is disposed above the heating wires 20, when temperature ranging from 43 degrees Celsius to 47 degrees Celsius is sensed by the temperature sensor 30, a maximum surface temperature of the housing 10 may be 41 degrees Celsius or lower.

Here, the thermostat may be used instead of the temperature sensor 30.

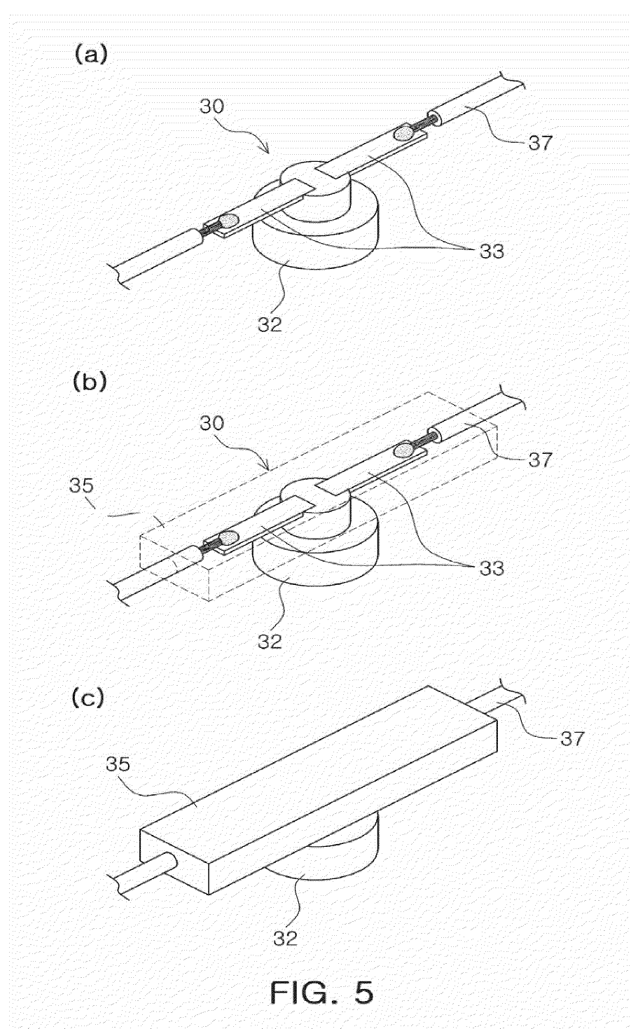

FIG. 5 is a view showing a connection relationship between the temperature sensor and wires according to an embodiment of the present invention. As shown in FIGS. 5(a), the temperature sensor 30 may include a temperature sensor main body 32 and terminals 33 which transfers a measured value of the temperature sensor 30 or through which current supplied to the temperature sensor 30 is input or output. The terminals 33 may be connected to the main body 32 of the temperature sensor 30.

As shown in FIG. 5(a), the terminals 33 are connected to wires 37 through soldering or a terminal. If water is introduced to the connection portion between the terminal 33 and the wires 37, there is a possibility of an electrical short or electric discharge which may cause a breakdown of the temperature sensor 30.

In order to waterproof the temperature sensor 30, in FIG. 5(b), a portion integrally molding the two terminals 33 and the wires 37 connected to the two terminals, respectively, is illustrated in the dotted line. FIG. 5(c) shows the temperature sensor 30 and the wires 37 after the molding is completed.

The molded portion 35 may be formed by forming a mold corresponding to the state in which the terminals 33 and the wires 37 of the temperature sensor 30 are connected, putting the temperature sensor 30 in the mold, and then injecting a resin into the mold. Here, various resins such as polyvinyl chloride (PVC), polypropylene (PP), epoxy, or the like, may be used, and in this embodiment, an epoxy resin is used.

The molded portion 35 covers the entirety of the terminals 33 and even portions of the coated portions of the wires 37, so even if water or moisture is introduced into the housing 10 of the toilet seat, there is no possibility that the temperature sensor 30 will malfunction or break down.

In this embodiment, the temperature sensor 30 having two terminals 33 is illustrated, but a plurality of terminals may be formed in the temperature sensor 30, and in this case, the molded portion 35 may be integrally formed to include all of the plurality of terminals 33.

Since the molded portion 35 is integrally formed to include all of the plurality of terminals 33, the formation of the molded portion 35 is simplified and there is no possibility in which water is applied to between a plurality of moldings.

Here, the thermostat may be used instead of the temperature sensor 30, and the thermostat and the terminals, i.e., the wire connection terminals, may be called a thermostat unit.

Although not shown, the method for regulating temperature of the heated bidet according to an embodiment of the present invention may include a toilet seat heating operation (S10), a power cutoff operation (S20), and a power re-supply operation (S30).

In the toilet seat heating operation (S10), the toilet seat may be heated by supplying power to the heating wires. The heating wires may be formed of PVC type nichrome wires, disposed within the toilet seat, and repeatedly bent from one end portion to the other end portion of the toilet seat. The heating wires may heat the toilet seat upon receiving power from the power source. The heating wires may be arranged to have a shape repeated at regular intervals so as to uniformly and evenly heat the toilet seat overall. The heating of the toilet seat may be based on a user's input.

In the toilet seat heating operation (S10), the thermostat may connect the heating wires and the power source.

In the power cutoff operation (S20), when the temperature of the toilet seat is increased up to a pre-set temperature value, the thermostat disconnects the heating wires and the power source, cutting a power supply.

The thermostat may be provided at a periphery of the heating wires, and serve as a switch for determining opening and closing between the power source and the heating wires. Namely, the opening and closing between the power source and the heating wires connected to the thermostat may be determined according to the temperature applied to the thermostat, by utilizing the characteristics of the bi-metal that the degree of bending varies according to temperature.

Thus, when the temperature of the toilet seat reaches the pre-set temperature value, the bi-metal is bent, disconnecting the heating wires and the power source. Namely, the portion between the heating wires and the power source may be open. The opening and closing of the thermostat may be determined only by the temperature applied to the thermostat.

In the power re-supply operation (S30), when the temperature of the toilet seat is dropped to be lower than the pre-set temperature value, the thermostat connects the heating wires and the power sources again to resume power supply.

When the temperature of the thermostat is dropped, the temperature of the bi-metal is also dropped, so the degree of bending of the bi-metal may be reduced. Accordingly, the bi-metal can connect the power source and the heating wires again.

Here, when the temperature of the toilet seat is increased again to reach the pre-set temperature value in the power re-supply operation (S30), the thermostat may open the connected heating wires and the power source again. Namely, the power cutoff operation (S20) and the power re-supply operation (S30) may be continuously repeated according to the temperature of the toilet seat while the bidet is in use.

Here, the thermostat may be separated from the heating wires by about 1 mm to 5 mm, and in this case, the pre-set temperature value may range from 43 degrees Celsius to 47 degrees Celsius.

Also, the thermostat may also be disposed above the heating wires, and in this case, the pre-set temperature value may range from 40 degrees Celsius to 44 degrees Celsius.

According to the related art method using the temperature sensor and the electronic control device, the temperature sensor measures the temperature of the toilet seat and transmits the measured temperature to the microcomputer (controller). Then, the microcomputer controls the quantity of power to be supplied to the heating wires according to the measured temperature, and measures the temperature of the toilet seat again to check it through a feedback process.

According to an embodiment of the present invention, the configuration of the microcomputer and the temperature sensor is not required, and controlling of the microcomputer and the temperature sensor is not required.

Thus, the temperature controlling method according to an embodiment of the present invention is advantageous in that it is simple and easily implemented, as compared with the related art method of using the temperature sensor and the electronic control device. Also, since a mechanical device such as the thermostat, rather than an electronic device such as the temperature sensor and the electronic control device vulnerable to moisture, is used, the causes of a breakdown can be reduced and a cause of a breakdown can be clearly specified.

As set forth above, according to embodiments of the invention, the temperature-controllable heated seat and heated bidet do not use an electronic device, or the like, and the housing can be controlled such that its maximum surface temperature does not exceed a certain allowable value.

Also, in the temperature-controllable heated seat and heated bidet, since the surface temperature of the housing is controlled through a mechanical operation, the temperature can be simply controlled compared with the related art temperature controlling method using electronic devices, or the like.

In addition, since the implementation method of the temperature-controllable heated seat and heated bidet is simple, the causes of a breakdown can be reduced and a cause of a breakdown can be clearly specified.

While the present invention has been shown and described in connection with the embodiments, it will be apparent to those skilled in the art that modifications and variations can be made without departing from the spirit and scope of the invention as defined by the appended claims.

What is claimed is:

1. A temperature-controllable heated seat comprising:
a housing providing a certain amount of internal space;
heating wires disposed within the housing, having bent portions repeated from one end portion to the other end portion of the housing, and heating the housing upon receiving power; and
a thermostat unit disposed at a periphery of the heating wires and controlling a power supply thereto, such that the temperature of the housing does not exceed a pre-set temperature value.

2. The temperature-controllable heated seat of claim 1, wherein the thermostat unit is separated from the heating wires by a predetermined distance.

3. The temperature-controllable heated seat of claim 2, wherein the predetermined distance ranges from 1 mm to 5 mm.

4. The temperature-controllable heated seat of claim 3, wherein the pre-set temperature value ranges from 43 degrees Celsius to 47 degrees Celsius.

5. The temperature-controllable heated seat of claim 1, wherein the thermostat unit is disposed above the heating wires.

6. The temperature-controllable heated seat of claim 5, wherein the pre-set temperature value ranges from 40 degrees Celsius to 44 degrees Celsius.

7. The temperature-controllable heated seat of claim 1, wherein the degree of precision of the thermostat unit ranges from 0.5 degrees Celsius to 2.5 degrees Celsius.

8. The temperature-controllable heated seat of claim 1, wherein the thermostat unit comprises a thermostat and wire connection terminals, and the wire connection terminals and wires connected thereto are integrally molded.

9. A temperature-controllable heated bidet comprising:
a toilet seat providing a certain amount of internal space;
heating wires disposed within the toilet seat, having bent portions repeated from one end portion to the other end portion of the toilet seat, and heating the toilet seat upon receiving power; and
a thermostat unit disposed at a periphery of the heating wires and controlling power supply to the heating wires such that the temperature of the toilet seat does not exceed a pre-set temperature value.

10. A method for controlling a temperature of a heated bidet, the method comprising:
a toilet seat heating operation of heating a toilet seat by supplying power to heating wires;
a power cutoff operation of cutting a power supply by disconnecting the heating wires and a power source by a thermostat when the temperature of the toilet seat reaches a pre-set temperature value; and
a power re-supply operation of resuming power supply by connecting the heating wires and the power source by the thermostat when the temperature of the toilet seat is dropped to be lower than the pre-set temperature value.
